(19) United States
(12) Patent Application Publication
(10) Pub. No.: US 2025/0239634 A1
(43) Pub. Date: Jul. 24, 2025

(54) DEVICE FOR RECIRCULATING ANODE GAS IN A FUEL CELL SYSTEM

(71) Applicant: PIERBURG GMBH, NEUSS (DE)

(72) Inventors: STEFAN ROTHGANG, RHEINBERG (DE); MICHAEL-THOMAS BENRA, NEUSS (DE); ANDREAS BURGER, NEUSS (DE)

(73) Assignee: PIERBURG GMBH, NEUSS (DE)

(21) Appl. No.: 18/704,464

(22) PCT Filed: Nov. 12, 2021
(86) PCT No.: PCT/EP2021/081494

§ 371 Date: Apr. 25, 2024

(51) Int. Cl. H01M 8/04089; F04D 25/06; F04D 29/58; F04D 29/70; H01M 8/04007

(52) U.S. Cl. CPC H01M 8/04097; F04D 25/06; F04D 29/5806; F04D 29/706; H01M 8/04074

(57) ABSTRACT

A device for an anode gas recirculation in a fuel cell system. The device includes a blower having a rotor wheel, a conveying channel which extends from a conveying channel inlet to a conveying channel outlet, an electric motor with a drive shaft on which the rotor wheel is attached, a condensate drain channel, and a cooling channel through which the anode gas flows. The cooling channel is arranged to least partially surround the electric motor. The cooling channel is defined by a radially outer wall and is provided as a droplet separator so that droplets can be discharged via the condensate drain channel.

### CROSS REFERENCE TO PRIOR APPLICATIONS

This application is a U.S. National Phase application under 35 U.S.C. § 371 of International Application No. PCT/EP2021/081494, filed on Nov. 12, 2021. The International Application was published in German on May 19, 2023 as WO 2023/083459 A1 under PCT Article 21 (2).

### FIELD

The present invention is directed to a device for anode gas recirculation in a fuel cell system and comprises a blower with a rotor wheel and a conveying channel extending from a conveying channel inlet to a conveying channel outlet, and an electric motor with a drive shaft on which the rotor wheel is attached.

### BACKGROUND

Fuel cell systems are used to convert chemical reaction energy of a continuously supplied fuel, in particular hydrogen, and an oxidizing agent, usually oxygen, into electrical energy, which can be used, for example, as electrical drive energy for vehicles. The hydrogen path of a low-temperature fuel cell, as is usually used in vehicles, essentially consists of the supply path of pure hydrogen via a pressure-reducing and metering valve, the actual fuel cell unit, and a recirculation path that connects the outlet of the fuel cell unit with its inlet, i.e., the hydrogen supply path, in a gas-tight manner. The resulting circuit is known as the anode gas recirculation circuit. This anode gas recirculation circuit is necessary in order to avoid releasing unused hydrogen into the atmosphere, which is present because the supply of fresh hydrogen to the fuel cell unit is over-stoichiometric. The anode gas circuit is therefore configured as a closed circuit and the unused hydrogen is fed back into the supply line downstream of the hydrogen dosing unit via a recirculation blower. Such blowers are, for example, configured as side channel blowers. These blowers are usually driven by electric motors which are supplied with voltage via the vehicle battery when operated in vehicles. Problematic with these drives is a high heat development of the electronic components and of the windings of the stator.

In addition to the unused hydrogen, the returned anode gas consists of the components nitrogen, which comes from the fresh air of the fuel cell unit, and water vapor. Liquid product water is also present at the outlet of the fuel cell unit, which is also conveyed via the recirculation blower.

In order to remove the water from the gas mixture, it is necessary to remove the water product and to condense the water vapor to the greatest extent possible. Condensers are used for this purpose.

To solve these problems, DE 10 2012 221 445 A1 describes an anode gas recirculation blower with a condenser that is configured on the rear of an electric motor of the blower and whose condensate is discharged into a cooling channel surrounding the electric motor. It has, however, been shown that the amount of water produced from the anode gas flow is often not sufficient to reliably cool the electric motor.

### SUMMARY

An aspect of the present invention is to provide a device for anode gas recirculation in a fuel cell system which provides for a sufficient removal of the water from the anode gas circuit and reliably prevents the electric motor from overheating. These functions should also require as little packaging space as possible.

An aspect of the present invention is to provide a device for an anode gas recirculation in a fuel cell system. The device includes a blower which comprises a rotor wheel, a conveying channel which extends from a conveying channel inlet to a conveying channel outlet, an electric motor which comprises a drive shaft on which the rotor wheel is attached, a condensate drain channel, and a cooling channel which is configured to have the anode gas flow therethrough and which is arranged to least partially surround the electric motor. The cooling channel is defined by a radially outer wall and is further configured as a droplet separator so that droplets can be discharged via the condensate drain channel.

### BRIEF DESCRIPTION OF THE DRAWINGS

The present invention is described in greater detail below on the basis of embodiments and of the drawings in which:

FIG. 1 shows a perspective view of a first embodiment of a blower of a device for anode gas recirculation in a fuel cell system according to the present invention;

FIG. 2 shows a perspective view of the blower from FIG. 1 with the outer housing section cut away;

FIG. 3 shows a sectional view of the head of the blower from FIG. 1;

FIG. 4 shows a side view of a second device according to the present invention for anode gas recirculation in a fuel cell system in a schematic representation; and

FIG. 5 shows a side view of a third device according to the present invention for anode gas recirculation in a fuel cell system in a schematic representation.

### DETAILED DESCRIPTION

The device for anode gas recirculation in a fuel cell system according to the present invention comprises a blower whose rotor wheel is rotatably arranged in a conveying channel so that the anode gas is conveyed by the rotor wheel from a conveying channel inlet to a conveying channel outlet. The rotor wheel is driven by an electric motor which drives a drive shaft to which the rotor wheel is attached. According to the present invention, the blower comprises a cooling channel through which the anode gas flows and which at least partially surrounds the electric motor of the blower. The anode gas can either be drawn through the cooling channel or pushed, depending on whether the cooling channel is arranged fluidically upstream or downstream of the conveying channel of the blower. The conveying channel is also defined by a radially outer wall which provides the flow around the electric motor. The cooling channel is configured as a droplet separator or serves as such, wherein the resulting droplets can be discharged via a condensate drain channel. The design of the cooling channel as a droplet separator can include various designs. Installations or precautions must in any case be taken which provide that the water is at least partially separated from the anode gas. This can be performed, for example, via centrifugal separation, but also using components that lead to a forced deflection of the gas flow. The temperature of the anode gas flow should thereby be brought to below 100° C. so as to be suitable for cooling the electronics and the stator of the electric motor. However, the cooling channel can at the same time be used as a condenser by providing appropriate components or by spiraling the anode gas around the electric motor at a sufficient speed. Both lead to the water being separated on the internal components or the outer wall due to the higher inertia compared to the gas and can be discharged via a condensate drain. This means that the cooling and condensation functions are realized in the cooling channel in a single process step and in a very small packaging space. The use of separate coolant can also be completely avoided.

The cooling channel can, for example, be arranged upstream of the conveying channel so that the water does not enter the conveying channel. This prevents damage to the blades of a rotor wheel and accordingly reduces wear. Corrosion can also be reduced.

The rotor wheel of the blower can, for example, be arranged completely above or below the electric motor, with the shaft being aligned in the direction of the acting gravitational force. The blower is therefore orientated vertically. The condensate is discharged at one of the axial ends so that the flow through the cooling channel remains unchanged and the water in the anode gas flow can in particular still be used for cooling over the entire circumference. If the rotor wheel is arranged below the electric motor, condensate can also be drained from the area of the conveying channel at the same position. The cooling channel can be flowed through from the rear of the blower to the front, i.e., towards the rotor wheel, as well as vice versa.

It is here pointed out that for the entire disclosure hereof, the terms “above”, “below”, “under”, “over”, “downwards” or “upwards” respectively refer to an installation direction in which the blower is, for example, installed in a vehicle. It is always assumed that a center of gravity serves as a reference point for the blower. The terms accordingly always refer to the direction of the acting gravitational force, wherein it is assumed that, for example, the vehicle is standing on a straight plane that is aligned perpendicular to the direction of gravity. If a first element is positioned above a second element, this therefore means that this first element is positioned further away from the earth's center of gravity than the second element.

It is furthermore advantageous if a wall defining the cooling channel at the bottom is configured to be inclined towards an opening that defines an inlet of the condensate drain channel. All the water dripping off the walls is thereby guided safely into the opening and thus to the condensate drain by the gravitational force acting thereon.

In an embodiment of the present invention, the inlet of the condensate drain channel can, for example, be arranged in the downward limiting wall on the radially outer area opposite the radially outer wall, as the main part of the water will settle on this outer wall and there run down. This is firstly due to the fact that the outer wall is usually colder than the inner wall and secondly due to the flow of the anode gas, which usually circulates around the electric motor, at least in sections, and thus the heavier water droplets are forced outwards against the radially limiting wall. This provides that the separated water is removed from the cooling channel as quickly and completely as possible.

In an embodiment of the present invention, an outlet of the condensate drain channel can, for example, be arranged at the lower end of the blower below the conveying channel. This prevents the condensate from flowing back towards the conveying channel.

An anode gas outlet of the cooling channel can, for example, lead directly into a conveying channel inlet. The anode gas or the water-reduced anode gas accordingly flows through the cooling channel and then through the conveying channel, wherein the conveying path between the conveying channel and the cooling channel is minimized.

It is also advantageous if the anode gas outlet of the cooling channel is arranged axially offset to the condensate drain channel and above the condensate drain channel. In such an arrangement, the condensate usually accumulates below the anode gas outlet of the cooling channel in order to reach the condensate drain channel and thus usually does not flow into the conveying channel against the force of gravity.

In an embodiment of the present invention, the anode gas outlet of the cooling channel can, for example, be arranged above the conveying channel and offset radially inwards from a radially outwardly bounding wall and can, for example, be radially spaced from the radially outwardly bounding wall. The condensate that runs along the radially outer wall does not therefore reach the anode gas outlet of the cooling channel, as the wall does not lead directly into the anode gas outlet due to the radial distance.

If the blower is installed in a position in which the conveying channel is arranged above the electric motor, the anode gas outlet of the cooling channel can, for example, be arranged below the conveying channel and the condensate drain channel can be configured on the axially opposite side of the blower, i.e., at the lower end. This has the advantage that the gas is conveyed in the opposite direction to the gravitational force acting on the liquid, which almost completely prevents the deposited water droplets from being entrained.

In an embodiment of the present invention, the cooling channel can, for example, open below the conveying channel into a space into which a pipe protrudes from above, which defines the anode gas outlet of the cooling channel, wherein the condensate drain is configured at the lower end of the space. Due to the expansion of the space available for the anode gas, water is also separated out, which accumulates in the lower space due to gravity and can flow off, while the gas is discharged upwards through the pipe, as in a cyclone separator. This provides a simple way of achieving a good degree of separation directly at the blower.

In an embodiment of the present invention, the anode gas outlet can, for example, be fluidically connected to the conveying channel inlet, and the conveying channel can, for example, be configured above the chamber so that the anode gas freed from water can flow directly from the chamber into the conveying channel. Cooling, condensation and conveying can thereby be provided in the smallest packaging space.

In an embodiment of the present invention, the cooling channel can, for example, surround the electric motor in a helical shape. Separation accordingly takes place in the form of a centrifugal separator. For this purpose, the cross-section of the cooling channel should not be too large, while a sufficient flow velocity in the cooling channel is provided. The heavier water droplets are thereby accelerated against the outer wall and flow along the wall down to the condensate drain channel.

In a further embodiment of the present invention, the radially outer wall of the helical cooling channel can, for example, be configured to be smooth. This minimizes the flow resistance for the anode gas flow and also provides that the condensate flows along this wall without interference.

In an embodiment of the present invention, the cooling channel can, for example, have a helical flow from top to bottom and the conveying channel can, for example, be arranged above the electric motor and be connected to the conveying channel inlet via a connecting channel, at the upstream end of which the condensate drain channel is configured. The water thus collects in the end area of the cooling channel at the lower end. While the anode gas flow is subsequently conveyed upwards to the conveying channel, the condensate can be discharged at the bottom, wherein entrainment is again prevented. This design also achieves an effect similar to that of a cyclone separator, wherein the connecting channel functions as an immersion tube. A very good separation and cooling effect is also achieved thereby.

In an embodiment of the present invention, baffle walls can, for example, be arranged in the cooling channel, the baffle walls being orientated at an angle of 45° to 135° to the main flow direction. The humid gas is guided through the baffle walls, through which the flow direction of the gas is deflected several times. The liquid droplets cannot follow these changes in direction, which is why they hit the components and settle there. As the droplets are deposited, they flow downwards. The droplets can then be accumulated in the lower area and discharged via the condensate drain channel. This is a simple way of using the cooling channel as a droplet separator. The baffle walls can be configured as solid walls or as grid walls. They can be configured in the cooling channel on both the inner and outer walls and close the flow path either completely or partially over an axial or radial cross-sectional area.

In an embodiment of the present invention, a baffle wall can, for example, be configured upstream of the anode gas outlet of the cooling channel, which covers the anode gas outlet when viewed in the circumferential direction. This provides that the anode gas flow still encounters a deflector before the outlet and that any remaining droplets are separated.

A device for anode gas recirculation in a fuel cell system is thus provided which requires little packaging space and at the same time provides cooling of the drive motor and water separation from the anode gas stream.

Two embodiments according to the present invention are shown in the drawings and are described below.

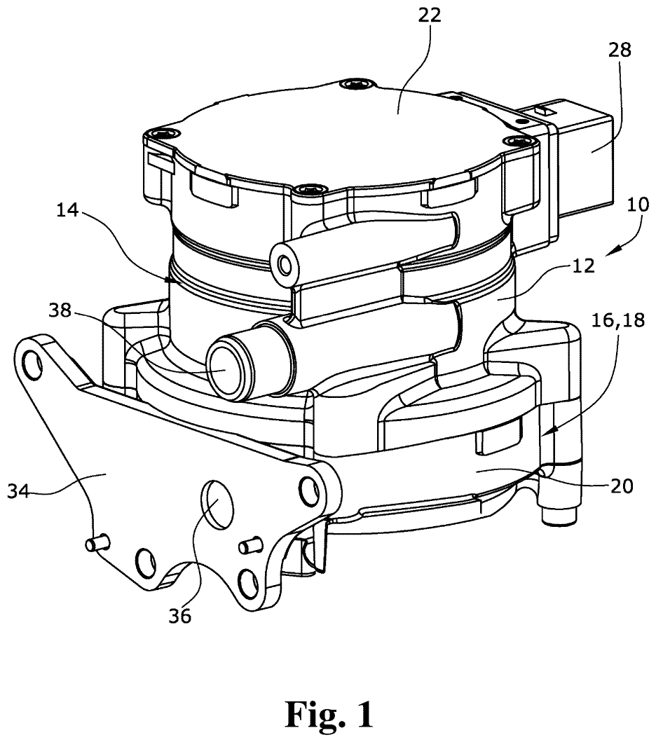

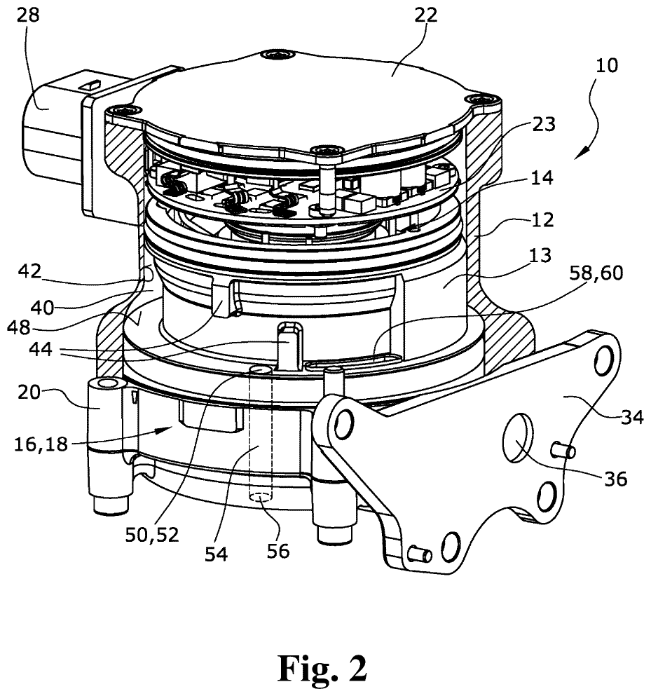

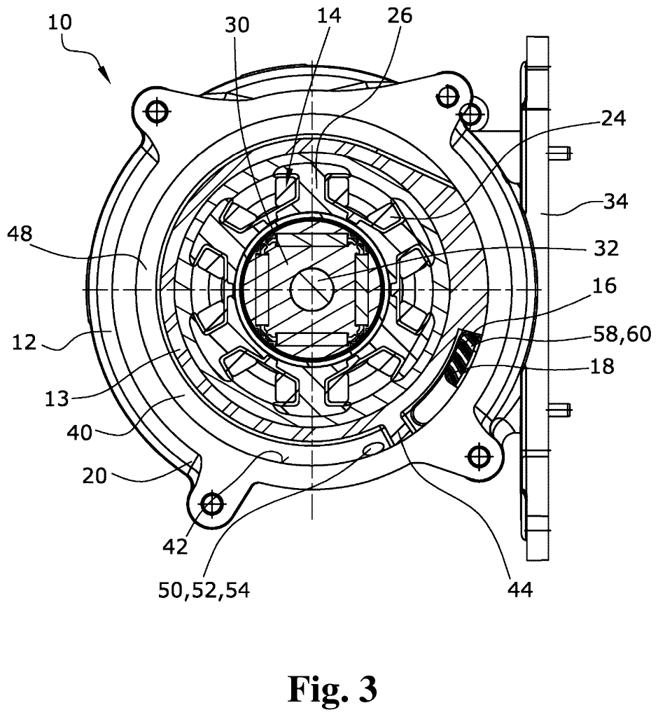

The blower 10 shown in FIGS. 1 to 3 comprises an outer motor housing part 12, which radially surrounds an inner motor housing part 13, in which an electric motor 14 is arranged, which drives a rotor wheel 16, via which an anode gas is conveyed via a conveying channel 18, which is at least partially configured in a blower head housing 20. The outer motor housing part 12 is attached to the blower head housing 20 and is closed on the axial side opposite the blower head housing 20 by a cover 22, behind which the electronics 23 of the electric motor 14 are arranged, which, like windings 24 of a stator 26, are connected to a voltage source via a plug 28. The stator 26 corresponds in a known manner with a permanent magnetic rotor 30, which is firmly attached to a drive shaft 32, to which the rotor wheel 16 is in turn attached.

In the present embodiment, a flange 34 is configured on the blower head housing 20, on which a conveying channel outlet 36 is configured, which is fluidically connected to the conveying channel 18. An anode gas inlet 38 is furthermore configured on the outer motor housing part 12, which leads into a cooling channel 40 which is configured between the inner motor housing part 13 and the outer motor housing part 12 and which at least partially surrounds the electric motor 14. The cooling channel 40 serves to dissipate heat from the electric motor 14 and is bounded radially outwards by a radially outer wall 42, which is defined by an inner wall of the outer motor housing part 12.

Baffle walls 44 are configured in the cooling channel 40 which extend axially into the cooling channel 40 from above and below so that a flow reversal is constantly forced in the cooling channel 40. The baffle walls 44 serve as components of a droplet separator 46, as water in the anode gas flow in the form of droplets or water vapor collides with the baffle walls 44 due to its higher inertia compared to the nitrogen and hydrogen present in the anode gas flow, collects and slides down in particular the radially outer wall 42, which is colder, and in the direction of which the droplets are carried by the centrifugal force due to the gravitational force. A wall 48 axially downwardly delimiting the cooling channel 40 is configured at an angle to an opening 50 so that the droplets collecting on the wall 48 slide to the opening 50, which serves as an inlet 52 of a condensate drain channel 54 extending from the inner motor housing part 13 through the blower head housing 20 to an outlet 56. The wall 48 is configured to slope downwardly both with respect to the horizontal and radially outwardly toward the opening 50, which is adjacent to the surrounding radially outer wall 42, so that water flows toward the opening 50 due to gravity.

An anode gas outlet 58, through which the water-reduced anode gas flows from the cooling channel 40, is arranged axially slightly higher than the inlet 52 of the condensate drain channel 54 in order to prevent water from flowing to the anode gas outlet 58. The anode gas outlet 58 is additionally arranged directly in the flow shadow of a final baffle wall 44, through which water is again separated immediately upstream of the anode gas outlet 58. The anode gas outlet 58 is furthermore arranged in a radially inner area of the cooling channel 40, thus comprising a radial distance from the radially outer wall 42, so that the inert water would also have to be transported inwards and thus outwards against the centrifugal force and the acceleration caused by the baffle wall 44 in order to reach the anode gas outlet 58 of the cooling channel 40.

The anode gas outlet leads directly into, or defines, a conveying channel inlet 60, via which the at least partially dried anode gas flows into the conveying channel 18, where it is compressed and flows to the conveying channel outlet 36, which is fluidically connected to a fuel cell stack, while the recovered condensate flows to the outlet 56 via the condensate drain channel 54. Cooling of the electric motor 14 and separation of the process water from the anode gas stream is thus simultaneously achieved.

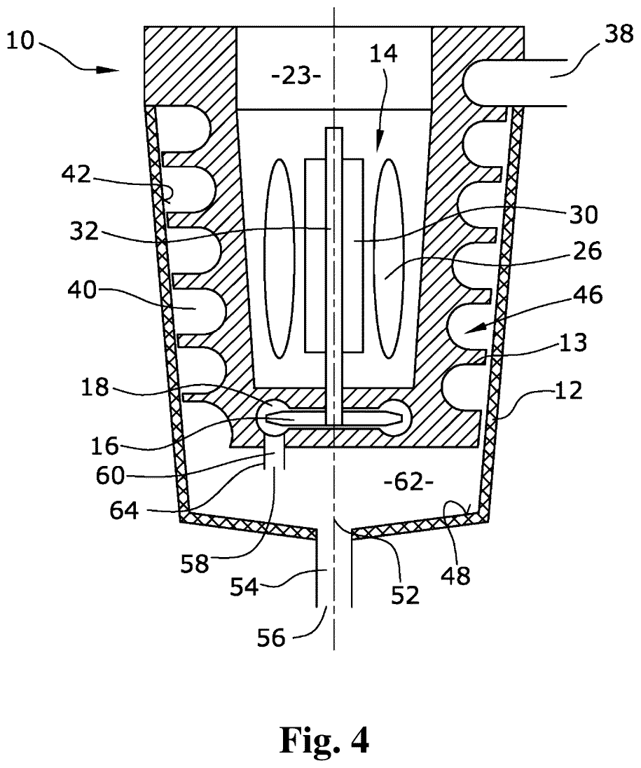

An alternative configuration of such a combined cooling and water separation system is shown schematically in FIG. 4, wherein the same reference signs are used below for identical components.

The droplet separator 46 used here acts as a cyclone separator in that the cooling channel 40 is configured in a helical shape, in which a sufficiently high flow velocity is achieved in order to separate the heavier water droplets and the water vapor from the remaining anode gas stream due to the centrifugal force present, by accelerating it outwards against the radially outer wall 42 due to its higher inertia. This radially outer wall 42 is configured to be smooth so that the water droplets hitting this radially outer wall 42, which is also colder, again slide down due to the gravitational force acting on them. In the lower region, the water separated in this way and the anode gas flow enter a space 62 in which expansion also takes place due to the widening of the cross-section, which can lead to an additional loss of temperature and thus to additional water droplets being formed. The already separated water in any case passes via the axially delimiting funnel-shaped and thus inclined wall 48 to the condensate drain channel 54, while the anode gas passes via a pipe 64 immersed in the space 62, which serves as the anode gas outlet 58 of the cooling channel 40, to the conveying channel 18, where it is recompressed and pumped in the direction of the fuel cell.

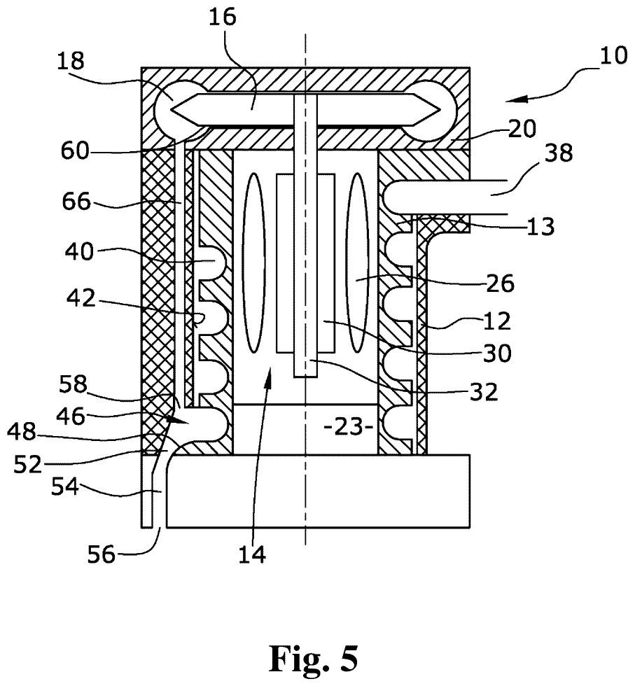

FIG. 5 shows an alternative embodiment in which, in contrast to the previous embodiments, the conveying channel 18 is this time arranged above the electric motor 14 so that the gravitational force in this case removes a liquid from the conveying channel 18. The anode gas inlet 38 into the cooling channel 40 takes place in the upper region of the blower 10. From here, the anode gas enters a helical cooling channel 40 corresponding to the embodiment described above so that the water is again deposited on the radially outer wall. From there, in the present embodiment, it passes directly into the adjoining condensate drain channel 54. The dried anode gas can, however, be conveyed following the pressure gradient via a connecting channel 66, which defines the anode gas outlet 58 of the cooling channel 40, in the direction of the conveying channel 18. The water and water vapor are thus separated from the anode gas flow by centrifugal forces and discharged by gravitational force.

In all three cases, the anode gas of the recirculation path is used directly to cool the electric motor driving the blower and, at the same time, water is continuously extracted from this gas. The required packaging space is thereby reduced and two functions of the system are integrated in one component, thus reducing costs.

A valve should of course be arranged downstream of the condensate drain channel, respectively, with which the condensate produced can be drained and which prevents anode gas from flowing into the condensate drain channel.

It should be clear that the described device for anode gas recirculation in a fuel cell system is not limited to the embodiments described. If the blower is a side channel blower, a second condensate drain can furthermore be configured at its lowest point in the conveying channel and, viewed in the direction of rotation of the rotor wheel, immediately upstream of an interrupter section of the conveying channel, via which residual moisture that enters the conveying channel can also still be separated. Different droplet separators can also be used or the various shown discharges of the separated substances can be combined differently with the various options for separation.

The present invention is not limited to embodiments described herein; reference should be had to the appended claims.

### LIST OF REFERENCE NUMERALS

10 Blower
12 Outer motor housing part
13 Inner motor housing part
14 Electric motor
16 Rotor wheel
18 Conveying channel
20 Blower head housing
22 Cover
23 Electronics
24 Windings
26 Stator
28 Plug
30 Permanent magnetic rotor
32 Drive shaft
34 Flange
36 Conveying channel outlet
38 Anode gas inlet
40 Cooling channel
42 Radially outer wall
44 Baffle walls
46 Droplet separator
48 Wall
50 Opening
52 Inlet
54 Condensate drain channel
56 Outlet
58 Anode gas outlet
60 Conveying channel inlet
62 Space
64 Pipe
66 Connecting channel

What is claimed is:

1-17. (canceled)

18. A device for an anode gas recirculation in a fuel cell system, the device comprising a blower which comprises:
a rotor wheel;
a conveying channel which extends from a conveying channel inlet to a conveying channel outlet;
an electric motor which comprises a drive shaft on which the rotor wheel is attached;
a condensate drain channel; and
a cooling channel which is configured to have the anode gas flow therethrough and which is arranged to least partially surround the electric motor, the cooling channel being defined by a radially outer wall and being further configured as a droplet separator so that droplets can be discharged via the condensate drain channel.

19. The device as recited in claim 18, wherein the cooling channel is further arranged to be upstream of the conveying channel.

20. The device as recited in claim 18, wherein,
the rotor wheel of the blower is arranged completely above or completely below the electric motor, and
the drive shaft is aligned in a direction of an acting gravitational force in a built-in state of the device.

21. The device as recited in claim 18, further comprising:
an outlet of the condensate drain channel, the outlet being arranged at a lower end of the blower below the conveying channel.

22. The device as recited in claim 18, further comprising:
an opening which defines an inlet of the condensate drain channel; and
a wall which defines the cooling channel at a bottom, the wall being configured to be inclined to the opening which defines the inlet of the condensate drain channel.

23. The device as recited in claim 22, wherein,
the wall is configured to be downwardly delimiting, and
the inlet of the condensate drain channel is arranged in the wall at a radially outer region which is opposite to the radially outer wall.

24. The device as recited in claim 23, further comprising:
an anode gas outlet of the cooling channel, the anode gas outlet being arranged to lead directly into the conveying channel inlet.

25. The device as recited in claim 24, wherein the anode gas outlet of the cooling channel is further arranged to be axially offset relative to and above the inlet of the condensate drain channel.

26. The device as recited in claim 24, wherein the anode gas outlet of the cooling channel is arranged above the conveying channel and is arranged to be offset radially inwards with respect to the radially outer wall and to comprise a radial distance from the radially outer wall.

27. The device as recited in claim 24, wherein
the anode gas outlet of the cooling channel is arranged below the conveying channel, and
the condensate drain channel is configured at an axially opposite side of the blower.

28. The device as recited in claim 24, further comprising:
a pipe which defines the anode gas outlet of the cooling channel; and
a space into which the pipe projects from above,
wherein,
the cooling channel is further configured to open below the conveying channel into the space, and
the inlet of the condensate drain channel is arranged at a lower end of the space.

29. The device as recited in claim 28, wherein,
the anode gas outlet of the cooling channel is fluidically connected to the conveying channel inlet, and
the conveying channel is arranged above the space.

30. The device as recited in claim 24, further comprising:
baffle walls which are arranged in the cooling channel, the baffle walls being orientated at an angle of 45° to 135° to a main flow direction.

31. The device as recited in claim 30, wherein one of the baffle walls is arranged upstream of the anode gas outlet of the cooling channel, the one of the baffle walls being arranged to cover the anode gas outlet as seen from a circumferential direction.

32. The device as recited in claim 18, wherein the cooling channel surrounds the electric motor in a helical shape.

33. The device as recited in claim 32, wherein,
the radially outer wall of the cooling channel surrounds the electric motor in the helical shape, and
the radially outer wall of the cooling channel is configured to be smooth.

34. The device as recited in claim 32, further comprising:
a connecting channel,
wherein,
the cooling channel is further configured to have a helical flow from a top to a bottom, and
the conveying channel is arranged above the electric motor and is connected via the connecting channel to the conveying channel inlet at an upstream end of which the condensate drain channel is arranged.
